(19) United States
(12) Patent Application Publication
(10) Pub. No.: US 2009/0282070 A1
(43) Pub. Date: Nov. 12, 2009

(54) APPLICATION CONTENTION MANAGEMENT SYSTEM METHOD THEREOF, AND INFORMATION PROCESSING TERMINAL USING THE SAME

(75) Inventor: Yoshinori Saida, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Minato-ku ,Tokyo (JP)

(21) Appl. No.: 11/720,727

(22) PCT Filed: Nov. 11, 2005
(86) PCT No.: PCT/JP2005/022421

§ 371 Date: Jun. 1, 2007

(30) Foreign Application Priority Data
Dec. 1, 2004 (JP) 2004-347944

(51) Int. Cl. G06F 17/00

(52) U.S. Cl. 707/102; 707/E17.03

(57) ABSTRACT

The application contention management system for an application on an information processing terminal, comprises data base generation unit which generates a contention information data base in which information related to contention is registered on a basis of the application, and contention determination unit which determines contention of the application based on the contention information data base.

### INCORPORATION BY REFERENCE

This application is based upon and claims the benefit of priority from Japanese patent application No. 2004-347944, filed on Dec. 1, 2004, the disclosure of which is incorporated herein in its entirety by reference.

### FIELD OF THE INVENTION

The present invention relates to an application contention management system and a method thereof, and an information processing terminal using the same and, more particularly, an application contention management system which manages contention of an application program (hereinafter simply referred to as an application) on an information processing terminal such as a portable communication terminal.

### DESCRIPTION OF THE RELATED ART

In a portable communication terminal whose representative is a cellular phone, because various kinds of computer resources such as a CPU, a hard disc, a memory and a network are poor as compared with a common personal computer, when an application uses a certain resource, there occurs a case where other application which is to use the resource can not be activated or a case where no transition to a state of using the resource is allowed, which is called contention between applications.

One example of a system which controls contention of applications on a portable communication terminal is recited in Japanese Patent Laying-Open No. 2003-177926. The application contention control system includes an inter-application contention determination means, a contention determination data holding means and a means for holding a state of an application being currently activated. Thus structured application contention control system described above operates in a manner described in the following.

More specifically, when activating a certain application on the portable communication terminal, the application inquires of the inter-application contention determination means about whether activation of the application is allowed or not. The contention determination means obtains information of an application being currently activated and of its state obtained from the means for holding a state of an application being currently activated and makes determination of contention between an application to be activated and the application being activated based on the obtained information and information about contention between applications held in the contention determination data holding means to determine whether activation is allowed or not. The application notified of a result of allowance/non-allowance of activation is activated or ended according to the notified instruction.

On the other hand, with reference to Japanese Patent Laying-Open No. 2003-177926, disclosed is a technique of executing, with information indicating how individual processing programs use shared resources are stored as exclusive control information in advance, exclusive control between processing programs by using the exclusive control information.

Problem in the above-described Japanese Patent Laying-Open No. 2003-177926 is that the volume of application contention determination data is enormous to make the number of contention determination data generation processes and the number of contention determination data rectification processes following addition of an application and the like be extremely large. The reason is that application contention determination data needs to be prepared corresponding to combinations of states that each application can take with respect to all the applications mounted on the portable communication terminal.

Assume, for example, that the number of applications mounted on the portable communication terminal is 30 and states that each application can take has five kinds, (30×5)×(30×5)=22,500 of combinations of contention determination data need to be prepared to make the number of data generation processes and maintenance processes be enormous. Here, a state that the application can take is, for example, a state of being in communication or a state of being in use of a card device.

Other problem in Japanese Patent Laying-Open No. 2003-177926 and Japanese Patent Laying-Open No. 10-049389 is that an application contention control mechanism fails to cope with dynamic addition of an application caused by downloading and the like. The reason is that there is no means for newly generating or updating contention determination data in the portable communication terminal.

### SUMMARY OF THE INVENTION

An exemplary object of the present invention is to provide an application contention management system and a method thereof, and an information communication terminal and a program using the same which facilitate generation and rectification of data for contention determination in the control of contention between applications on an information communication terminal such as a portable communication terminal.

According to an exemplary aspect of the invention, an application contention management system for an application on an information processing terminal, comprises data base generation unit which generates a contention information data base in which information related to contention is registered on a basis of said application, and contention determination unit which determines contention of said application based on said contention information data base.

### BRIEF DESCRIPTION OF THE DRAWINGS

FIG. 1 is a block diagram showing a structure of a first mode of implementation of the present invention;

FIG. 2 is a flow chart showing part of operation of the mode of implementation shown in FIG. 1;

FIG. 3 is a flow chart showing part of operation of the mode of implementation shown in FIG. 1;

FIG. 4 is a block diagram showing a structure of a second mode of implementation of the present invention;

FIG. 5 is a flow chart showing operation of the mode of implementation shown in FIG. 4:

FIG. 6 is a block diagram showing a structure of a third mode of implementation of the present invention;

FIG. 7 is a flow chart showing the structure of the mode of implementation shown in FIG. 6;

FIG. 8 is a diagram showing an example of an application contention information file;

FIG. 9 is a diagram showing an example of contention determination data shown in Japanese Patent Laying-Open No. 2003-177926; and

FIG. 10 is a diagram showing an example of data while in operation which is shown in Japanese Patent Laying-Open No. 2003-177926.

### DESCRIPTION OF THE PREFERRED EMBODIMENT

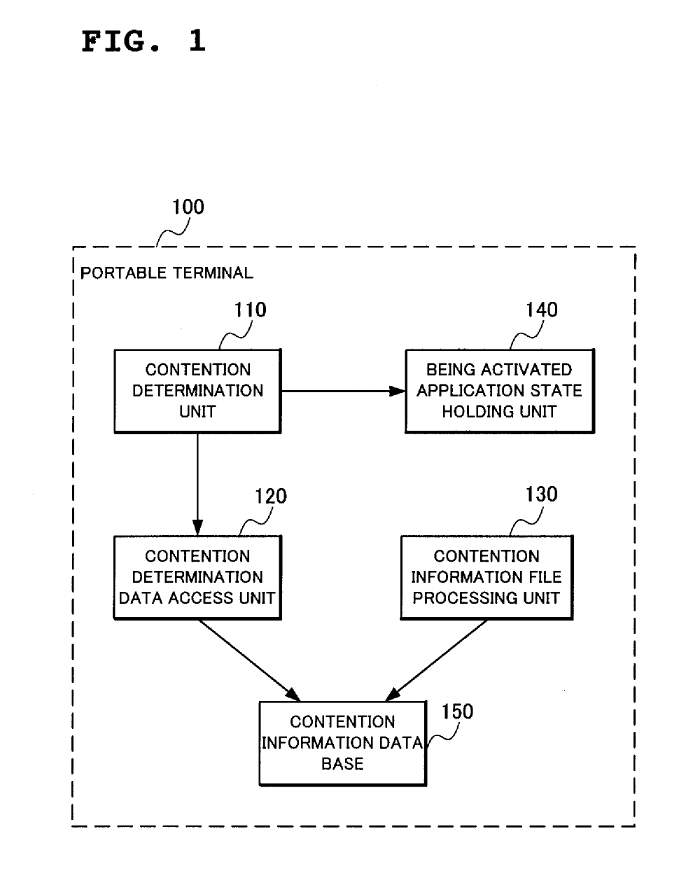

In the following, modes of implementation of the present invention will be described in detail with reference to the accompanying drawings. With reference to FIG. 1, a functional block of a first mode of implementation of the present invention is illustrated, which mode of implementation includes a contention determination unit 110, a contention determination data access unit 120, a contention information file processing unit 130, a being activated application state holding unit 140 and a contention information data base 150 on a portable communication terminal (hereinafter referred to as portable terminal) 100. These unit operate substantially in the following manner, respectively.

Upon receiving an inquiry about whether activation or a state transition within an application is allowed or not from the application, the contention determination unit 110 takes out information about an application in activation which is held in the being activated application state holding unit 140 and obtains determination data of contention between the application in activation and the inquired application from the contention information data base 150 by using the contention determination data access unit 120 to return allowance/non-allowance of activation to the application as an inquirer based on the determination data.

Upon receiving an instruction from the contention determination unit 110, the contention determination data access unit 120 takes out determination data of contention between designated applications from the contention information data base 150 and returns the same. The contention information file processing unit 130 reads a contention information file prepared for each application to register the file as contention determination data with information about contention between applications described at the contention information data base 150. The being activated application state holding unit 140 is for holding information about an application being currently activated on the portable terminal 100 and its state.

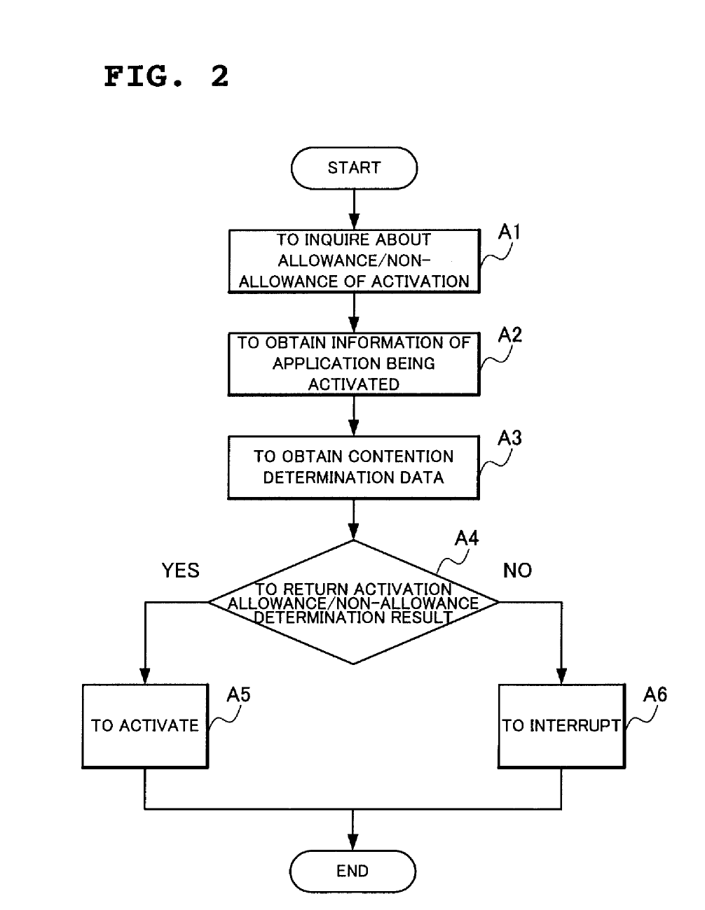

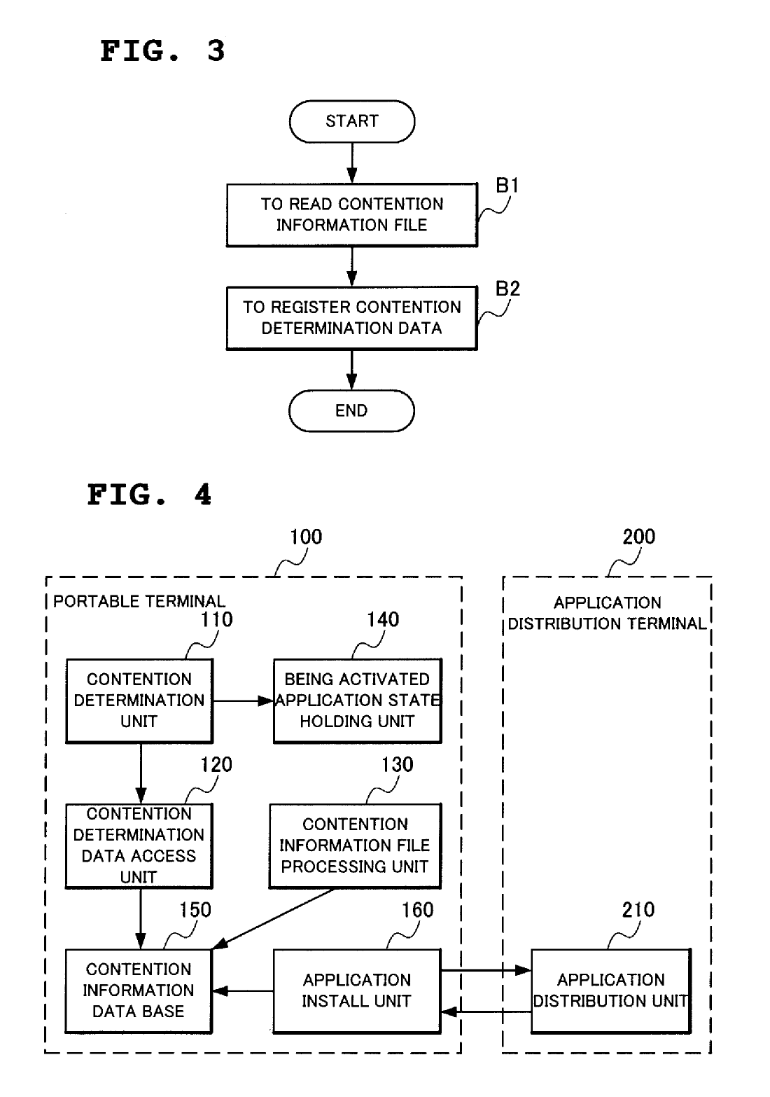

Next, with reference to the flow charts of FIG. 2 and FIG. 3, entire operation of the present mode of implementation shown in FIG. 1 will be detailed. First, when on the portable terminal 100, an application is activated or makes a state transition to other state within the application, the application inquires of the contention determination unit 110 about allowance/non-allowance of activation and a state transition (Step A1). Next, the contention determination unit 110 obtains information about an application being currently activated on the portable terminal 100 and about its state from the being activated application state holding unit 140 (Step A2).

Thereafter, the contention determination unit 110 obtains determination data of contention between a state of the application inquired at Step A1 and a state of the application in activation obtained at Step A2 from the contention information data base 150 by using the contention determination data access unit 120 (Step A3). The contention determination unit 110 having obtained the contention determination data makes a reply about whether activation or a state transition is allowed or not to the application as an inquirer based on the determination data (Step A4). Lastly, the application having made an inquiry executes activation, a state transition (Step A5) or such processing as interruption (Step A6) according to the reply result of the contention determination unit 110.

Here, prior to the above-described processing shown in FIG. 2, such processing is executed by the contention information file processing unit 130 as reading a contention information file with contention information described which is prepared for each application (Step B1) and registering the file as contention determination data at the contention information data base 150 (Step B2) as shown in FIG. 3.

Thus, because the present mode of implementation is structured to prepare a contention information file in which contention information is described on an application basis to generate and update a contention information data base based on the file, first generation of contention information or updating of contention information following addition and deletion of an application can be realized by a smaller number of processes than that of a related method.

Next, a second mode of implementation of the present invention will be detailed with reference to FIG. 4. In FIG. 4, the same parts as those in FIG. 1 are indicated by the same reference numerals. With reference to FIG. 4,, the second mode of implementation of the present invention includes the portable terminal 100 and an application distribution terminal 200. The portable terminal 100 and the application distribution terminal 200 are assumed to be connected by a wired or radio communication unit.

The portable terminal 100 includes the contention determination unit 110, the contention determination data access unit 120, the contention information file processing unit 130, the being activated application state holding unit 140, the contention information data base 150 and an application install unit 160. The application distribution terminal 200 includes an application distribution unit 210. These unit operate substantially in the following manner, respectively.

Assume that on the portable terminal 100, the contention information data base 150 corresponding to contention information of each application on the portable terminal 100 is already generated by the procedure described in the above first mode of implementation. Upon receiving an inquiry whether activation or a state transition within an application is allowed or not from the application, the contention determination unit 110 takes out information about an application being activated held in the being activated application state holding unit 140 and obtains determination data of contention between the being activated application and the inquired application from the contention information data base 150 by using the contention determination data access unit 120 to return allowance/non-allowance of activation to the application as an inquirer based on the determination data.

The contention information file processing unit 130 reads a contention information file prepared for each application and registers the file as contention determination data with information about contention between applications described at the contention information data bases 150. In addition, when an application is newly installed in the portable terminal 100 by using the application install unit 160, read a contention information file with contention information of a new application described to add contention determination data related to the new application to the contention information data base 150.

Upon receiving an instruction from the contention determination unit 110, the contention determination data access unit 120 takes out determination data of contention between the designated applications from the contention information data base 150 and returns the same. The being activated application state holding unit 140 is for holding information related to an application being currently activated on the portable terminal 100 and its state.

By using the application distribution unit 210 on the application distribution terminal 200, the application install unit 160 downloads a new application and a contention information file with contention information of the application described and installs the same in the portable terminal 100. With a plurality of applications held and managed, the application distribution unit 210 distributes an application and a contention information file of the application to the portable terminal 100 in response to a request from the application install unit 160 on the portable terminal 100.

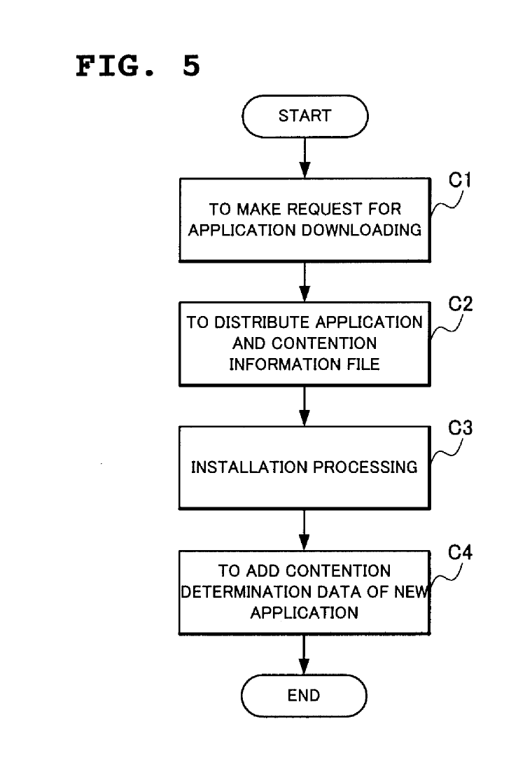

Next, entire operation of the present mode of implementation will be detailed with reference to the flow chart in FIG. 5. Assume here that related to an application installed on the portable terminal 100 in advance, contention determination data is registered in the contention information data base 150 by the procedure described in the first mode of implementation and description will be made of a procedure to follow.

First, the application install unit 160 on the portable terminal 100 issues a download request for an application to be newly installed in the portable terminal 100 to the application distribution unit 210 on the application distribution terminal 200 (Step C1). The application distribution unit 210 having received the download request distributes the designated application and a contention information file with contention information of the application described to the portable terminal 100 (Step C2).

The application install unit on the portable terminal 100 having received the application and the contention information file distributed from the application distribution unit 210 executes processing of installing the application in the portable terminal 100 (Step C3). Lastly, the contention information file processing unit 130 reads a contention information file of the new application to add contention determination data related to the new application to the contention information data base 150 (Step C4).

This arrangement makes it possible to apply application contention control also to an application newly installed by using the mechanism described in the first mode of implementation similarly to an existing application.

Since the present mode of implementation is structured to, when adding an application from the outside of the terminal to the portable terminal 100 by using the application install unit 160, simultaneously download a contention information file of the relevant application and process the file by using the contention information file processing unit 130 to additionally register contention determination data to the contention information data base 150, the same inter-application contention control can be realized for a newly added application as that for a related application.

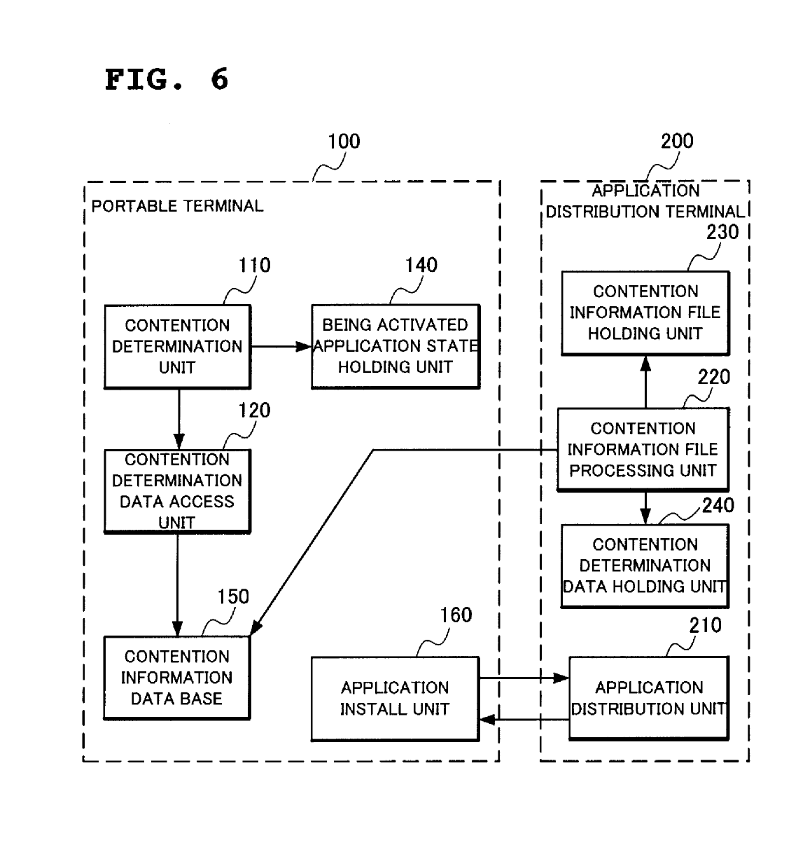

Next, a third mode of implementation of the present invention will be detailed with reference to FIG. 6. In FIG. 6, like parts in FIG. 1 and FIG. 4 are indicated by the same reference numerals. With reference to FIG. 6, the third mode of implementation of the present invention includes the portable terminal 100 and the application distribution terminal 200. The portable terminal 100 and the application distribution terminal 200 are connected by a wired or radio communication means.

The portable terminal 100 includes the contention determination unit 110, the contention determination data access unit 120, the being activated application state holding unit 140, the contention information data base 150 and the application install unit 160. The application distribution terminal 200 includes the application distribution unit 210, a contention information file processing unit 220, a contention information file holding unit 230 and a contention determination data holding unit 240. These unit operate substantially in the following manner, respectively.

Upon receiving an inquiry whether activation or a state transition within an application is allowed or not from the application, the contention determination unit 110 takes out information of an application being activated which is held in the being activated application state holding unit 140 and obtains determination data of contention between the application in activation and the inquired application from the contention information data base 150 by using the contention determination data access unit 120 to return an allowance/non-allowance of activation to the application as an inquirer based on the determination data.

Upon receiving an instruction from the contention determination unit 110, the contention determination data access unit 120 takes out determination data of contention between the designated applications from the contention information data base 150 and returns the same. The being activated application state holding unit 140 is for holding information related to the application being currently activated on the portable terminal 100 and its state.

The application install unit 160 downloads a new application and contention determination data by using the application distribution unit 210 on the application distribution terminal 200 to install the application in the portable terminal 100, as well as registering the downloaded contention determination data at the contention information data base 150.

The contention information file processing unit 220 reads a contention information file prepared for each application which is preserved in the contention information file holding unit 230 to register the file as contention determination data with information about contention between applications described at the contention determination data holding unit 240.

The contention information file holding unit 230 holds each contention information file of the applications installed on the portable terminal 100. In addition, upon newly adding an application to the portable terminal 100, a contention information file of the relevant application is added. The contention determination data holding unit 240 is for holding contention determination data generated by the contention information file processing unit 220.

The application distribution unit 210 holds and manages a plurality of applications. Upon a request for downloading an application from the application install unit 160 on the portable terminal 100, first, a contention information file of the relevant application is added to the contention information file holding unit 230. Next, update contention determination data on the contention determination data holding unit 240 by using the contention information file processing unit 220 and thereafter distribute the application whose downloading is requested and the contention determination data held in the contention determination data holding unit 240 to the portable terminal 100.

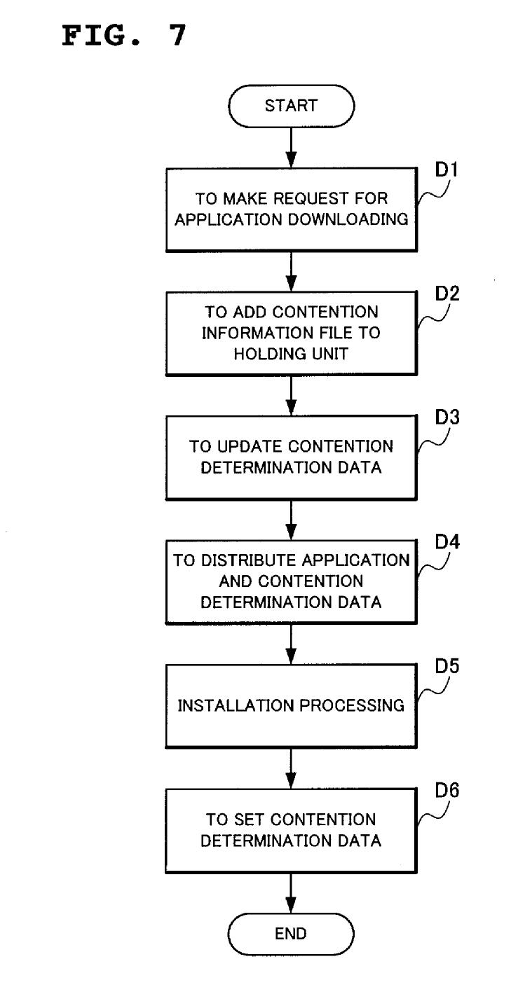

Next, entire operation of the present mode of implementation will be detailed with reference to the flow chart in FIG. 7. First, the application install unit 160 on the portable terminal 100 issues a request for downloading an application to be newly installed in the portable terminal 100 to the application distribution unit 210 on the application distribution terminal 200 (Step D1). The application distribution unit 210 having received the download request adds a contention information file with contention information of the designated application described to the contention information file holding unit 230 (Step D2). Assume here that a contention information file of each application installed on the portable terminal 100 is already held in the contention information file holding unit 230.

The contention information file processing unit 220 reads a contention information file in the contention information file holding unit 230 to generate contention determination data also including contention information of the application to be newly added and updates contention determination data in the contention determination data holding unit 240 (Step D3). The application distribution unit 210 distributes the application requested by the application install unit 160 and the contention determination data in the contention determination data holding unit 240 to the portable terminal 100 (Step D4).

The application install unit 160 on the portable terminal 100 having received the application and the contention determination data distributed from the application distribution unit 210 executes processing of installing the application in the portable terminal 100 (Step D5). The application install unit 160 at the same time sets the received contention determination data to the contention information data base 150 (Step D6).

The present mode of implementation is structured such that at the time of adding an application from the outside of the terminal to the portable terminal 100 by using the application install unit 160, contention determination data is generated on the application distribution terminal 200 side, transmitted to the portable terminal 100 and registered at the contention information data base 150, thereby realizing the same inter-application contention control as that of the first and second modes of implementation.

In addition, unlike the first and second modes of implementation, because of a structure in which the contention information file processing unit is mounted not on the portable terminal 100 but on the application distribution terminal 200, more saving of a ROM capacity for storing the contention information file processing unit and more saving of RAM and CPU resources for generating contention determination data by the contention information file processing unit on the portable terminal 100 can be realized than those in the first and second modes of implementation.

### (EMBODIMENT)

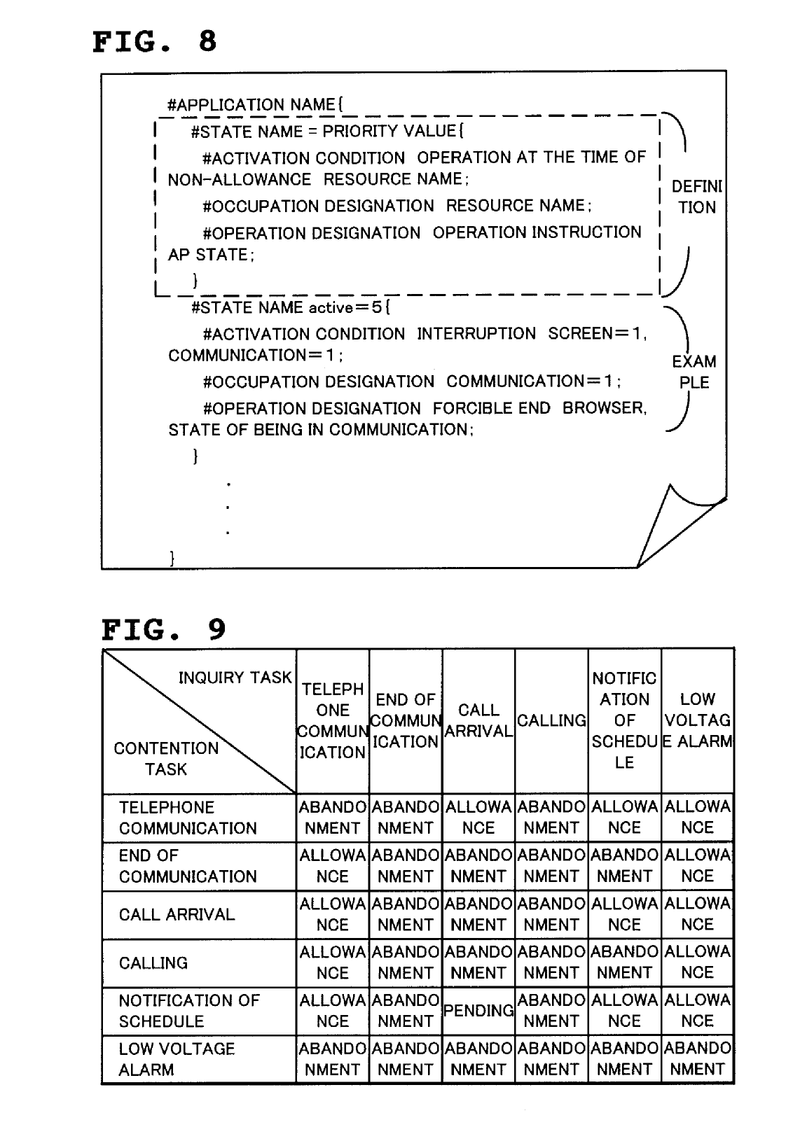

In the following, the present invention will be described with respect to a specific embodiment. A first embodiment of the present invention is as follows. First, for each application operating on the portable terminal, prepare a contention information file with each contention information described. FIG. 8 shows an example of the contention information file.

As shown in FIG. 8, various kinds of contention information is described for each state that a target application can take in a contention information file. As a state that an application can take, there are, for example, an active state, a state of being in radio communication, a state of being in infrared communication, a suspended state and an emergency state. In the contention information file, a priority value is set for each state, which can be used at the time of contention determination processing which will be described later.

In each state of the contention information file, three kinds of sentences, ┌1. activation condition┘, ┌2. occupation designation┘ and ┌3. operation designation┘ are described. Described in ┌1. activation condition┘ is a condition for a target application to be activated at that state or to transit from other state to that state.

In the portable terminal, because various kinds of computer resources such as a CPU, a hard disc, a memory and a network are poor as compared with a common personal computer, when an application uses a certain resource, there occurs a case where other application using the resource can not be activated or a case where no transition to a state of using the resource is allowed, which is called contention between applications. Activation conditions described here designate resources which should be usable at the time of activation or a transition of a corresponding application state.

With a cellular phone, because of giving preference to user operability or other reasons, even when no contention between actual resources exists, there occurs a case where when a certain application is activated, activation of no other specific application will be allowed. Although there is a case, for example, where when editing a telephone directory, such operation specification of a terminal is set as displaying no mail arrival screen, this is not because some resources contend with each other in particular but because of giving preference to user s operability, instinctive easiness to find or the like. In the present invention, to cope with such type of contention between applications not derived from actual resources as well, a virtual resource is defined to consider the above-described contention between applications to occur due to competition for the virtual resource.

In the example shown in FIG. 8, the activation condition sentence includes designation of operation to be executed when failing to meet the condition, and designation of resource names as conditions and the number of the same (designation of a plurality of combinations is possible). Possible designation of operation to be executed when failing to meet the condition includes such designation as interruption, pending and asking for user s determination. Designated as resource names are actual resources such as radio communication and a memory card and virtual resources described above together with numbers of their conditions. At contention determination, when resources designated here are usable as many as the designated number, activation or a state transition of a target application is allowed. When failing to meet these conditions, no activation or no state transition will be allowed, so that operation designated by operation designation as of when the conditions are not satisfied among the activation condition sentence is executed.

Described in ┌2. occupation designation┘ is a resource to be actually occupied when an application is activated at a target state or when it makes a state transition to the target state. ┌1. activation condition┘ only designates a source usable at the time of activation or a state transition, and a resource to be actually occupied after activation or after a state transition is described in the occupation designation. Although when an application is activated at a normal state, for example, a radio communication resource needs to be usable, this enables operation to be realized of allowing an application using other radio communication resource to be activated without occupying a radio communication resource while at the normal state. Similarly, when the relevant application makes a transition from the normal state to a state of being in communication, such operation can be realized as occupying a radio communication resource and allowing no activation of an application using other radio communication resource.

In the example shown in FIG. 8, designated in the occupation designation sentence are resource names to be occupied and the number thereof (a plurality of combinations can be designated). At the time of contention determination, an occupation designation sentence designated for a state of an application being activated is checked to consider that as many resources described therein are occupied as the designated number.

┌3. operation designation┘ is for designating, when an application is activated at a target state or makes a transition to the target state, such operation as ending or pending to other application. This enables, when a JAVA (registered trademark) application operates on a portable terminal, for example, such operation to be realized at an arrival of a telephone call as activating a telephone application to end the JAVA (registered trademark) application.

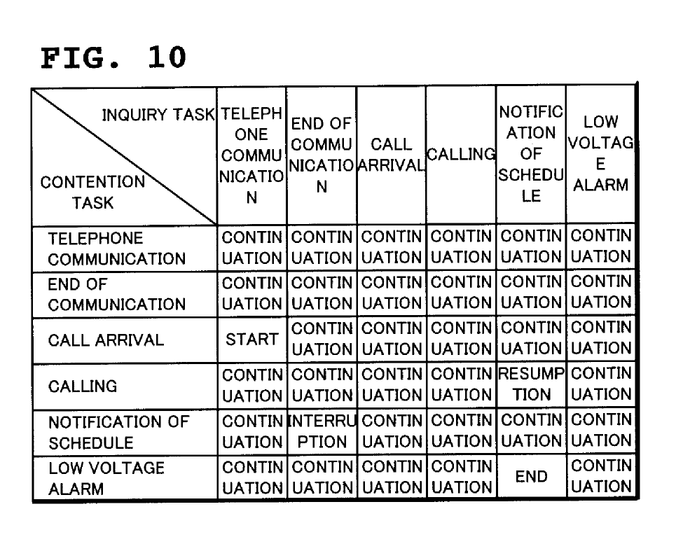

In the example shown in FIG. 8, described in the operation designation sentence are operation to be designated, and an application as a target and its state. In Japanese Patent Laying-Open No. 2003-177926, as shown in Table 2 and Table 3 in the specification of the literature (directly referred to in FIG. 9 and FIG. 10), presented as application contention information is a form of a table showing each state of an application corresponding to each state of an application (contention task to inquiry task), in elements of which tables, contention determination data such as ┌allowance┘ and ┌abandonment┘ is described.

In a case of description in such a form, when an application is newly added to the portable terminal, information about contention between each state of an existing application and each state of the new application needs to be sequentially described in the table to make the number of processes be enormous (as to details of FIG. 9 and FIG. 10, see the above-described Japanese Patent Laying-Open No. 2003-177926).

On the other hand, not by directly designating other contending application in the contention information file but by designating a resource as a cause of contention, the present invention enables a contention information file to be prepared individually for each application, thereby drastically reducing labor for contention information updating at the time of adding a new application to a portable terminal.

The contention information file processing unit 130 sequentially reads a contention information file prepared for each application and registers the same as contention determination data at the contention information data base 150 in advance. Next, description will be made of a flow of contention determination processing at the time of actually activating a certain application at a certain state. First, when the application is activated or makes a transition to other state within the application on the portable terminal 100, the application inquires of the contention determination unit 110 whether activation and a state transition are allowed (Step Al in FIG. 2). Next, the contention determination unit 110 obtains information of an application being currently activated on the portable terminal 100 and its state from the being activated application state holding unit 140 (Step A2 in FIG. 2). At this time, there might occur a case where a plurality of applications are being activated.

Thereafter, the contention determination unit 110 obtains determination data of contention between the state of the application inquired at Step Al and the state of the application being activated which is obtained at Step A2 from the contention information data base 150 by using the contention determination data access unit 120 (Step A3 in FIG. 2)

More specifically, first related to the state of the application in activation, take out priority information in the contention information file and information related to an occupied resource which is described in the occupation designation sentence from the contention information data base 150. When a plurality of applications are in activation, repeat the operation with respect to all the applications in activation. Thereafter, take out priority information in the contention information file and information of a resource as an activation condition described in the activation condition sentence related to a state of the inquired application which is to be activated this time or to make a state transition. Thereafter, first compare only the priority information and when priority of the state of the application which is to be activated or to make a state transition this time is higher than that of the application in activation, activation will be allowed.

Otherwise, compare these occupied resource and activation condition resource and a total of resources usable on the portable terminal 100 and when the resource as the activation condition is usable, activation will be allowed, so that the contention determination data to be returned will indicate allowance of activation. On the other hand, when the same is not usable, returned as contention determination data is information about operation designated by operation designation in a case of a failure in meeting conditions, which, related to the state of the application to be activated or to make a state transition this time, is described in the activation condition sentence in the contention information file.

The contention determination unit 110 having obtained the contention determination data replies to the application as an inquirer whether activation or a state transition is allowed or not based on the determination data (Step A4 in FIG. 2). Lastly, the application having made the inquiry executes activation, a state transition (Step A5 in FIG. 2) or such processing as interruption according to the result of the reply from the contention determination unit 110 (Step A6 in FIG. 2). In a case where the operation designation sentence is described in the contention information file, when an application designated therein is in activation, execute processing designated by the operation designation sentence (ending, pending, etc.).

Next, a second embodiment will be described. In the second embodiment, assume that the contention information data base 150 related to an application already installed in the portable terminal 100 is first generated by the procedure described in the first embodiment. Consideration will be here given to a case of installing a new application therein.

First, the application install unit 160 on the portable terminal 100 issues a request for downloading an application to be newly installed in the portable terminal 100 to the application distribution unit 210 on the application distribution terminal 200 (Step C1 in FIG. 5). The application distribution unit 210 having received the download request distributes the designated application and a contention information file with contention information of the application described to the portable terminal 100 (Step C2).

As described in the first embodiment, the contention information file is prepared on an application basis and its contents should be only description of information related to the application (activation condition, occupation designation, operation designation) which needs not be sequential description of information of contention with each state of other application as in Japanese Patent Laying-Open No. 2003-177926. Accordingly, at the time of thus adding and installing an application from the outside of the terminal, it is only necessary to newly add only a contention information file of the application and not necessary to change the contention information file of the application already installed in the terminal,

The application install means on the portable terminal 100 having received the application and the contention information file distributed from the application distribution unit 210 executes processing of installing an application in the portable terminal 100 (Step C3). Lastly, the contention information file processing unit 130 reads a contention information file of the new application to add contention determination data related to the new application to the contention information data base 150 (Step C4).

This enables application contention control to be executed also to a newly installed application by the procedure described in the first embodiment similarly to an existing application.

Next, a third embodiment will be described. The third embodiment, which is realized by moving the contention information file processing unit provided in the portable terminal 100 in the first and second embodiments to the outside of the terminal (the application distribution terminal 200 in FIG. 6), has a processing procedure of registering data which is read from a contention information file of each application and processed by the contention information file processing unit 220 on the application distribution terminal 200 at the contention information data base in the portable terminal 100 through a communication means. In the present embodiment, the application distribution unit 210 and the contention information file processing unit 220 need not to be always provided in the same terminal and they may be provided on separate terminals.

While the above-described modes of implementation and embodiments have been described with respect to a case of use for application contention control on a portable terminal, it is apparent that they are not exclusively used therefor but are applicable to an information processing terminal. They are also applicable to such use as an information search device for searching a synonym from a data base or a program for realizing the information search device on a computer and furthermore applicable to such use as a kana-kanji conversion device with the function of searching a synonym mounted on a personal computer or a word processor or a kana-kanji conversion function on a computer.

In addition, it is also apparent that with an operation procedure of each operation flow shown in FIG. 2, FIG. 3, FIG. 5 and FIG. 7 stored as a program in a recording medium such as a ROM in advance, the program can be read and executed by a computer.

According to the present invention, with the provisions of a contention information file processing unit for processing a contention information file prepared for each application to generate and update a contention information data base and a contention data base access unit for obtaining contention information from thus generated contention information data base, when activating an application, the system operates to obtain contention information corresponding to a state of the application and that of an application being currently activated by using the contention data base access unit from the contention information data base generated by the contention information file processing unit in advance, thereby determining whether activation is allowed or not. Adopting such a structure enables the above-described object of the present invention to be attained.

First effect of the present invention is to facilitate generation and updating of contention data. The reason is that a file with contention information described is prepared on an application basis to generate contention information data from the same by using the contention information file processing unit. In addition, the second effect of the present invention is to enable application contention control even when an application is dynamically added. The reason is that only a contention information file related to a newly added application is prepared and at the time of adding an application, the file is distributed as attached, thereby enabling processing of addition to contention information data by using the contention information file processing unit.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

1. An application contention management system for an application on an information processing terminal, comprising:
data base generation unit which generates a contention information data base in which information related to contention is registered on a basis of said application; and
contention determination unit which determines contention of said application based on said contention information data base.

2. The application contention management system according to claim 1, wherein said data base generation unit reads a file with contention information of said application described on a basis of said application to generate said contention information data base.

3. The application contention management system according to claim 2, wherein said data base generation unit interprets priority of each state of the application which is described in said file and registers the interpretation at said contention information data base, and said contention determination unit determines contention of said application based on said priority information.

4. The application contention management system according to claim 2 or claim 3, wherein said data base generation unit interprets an activation condition for a resource in said information processing terminal with respect to each state of the application which is described in said file and registers the interpretation at said contention information data base, and said contention determination unit determines contention of said application based on said activation condition.

5. The application contention management system according to any of claim 2 through claim 4, wherein said data base generation unit interprets a resource occupation condition in said information processing terminal with respect to each state of the application which is described in said file and registers the interpretation at said contention information data base, and said contention determination unit determines contention of said application based on said resource occupation condition.

6. The application contention management system according to any of claim 2 through claim 5, wherein said data base generation unit interprets an operation instruction to other application at the time of activation of the application which is described in said file and registers the interpretation at said contention information data base, and said contention determination unit executes said operation instruction at the time of activation of the application.

7. The application contention management system according to any of claim 2 through claim 6, wherein said data base generation unit, when a new application is installed from the outside of said information processing terminal, interprets a file with contention information of the new application described which is sent at the same time and additionally registers the interpretation at said contention information data base, and said contention determination unit determines contention of said application based on said additionally registered contention information of the new application.

8. The application contention management system according to any of claim 2 through claim 7, wherein said data base generation unit, which is provided in an external information processing terminal connected to said information processing terminal by wired or radio communication unit, transmits and registers data obtained by interpreting said file to and at said contention information data base by using said communication unit.

9. An application contention management method on an information processing terminal, comprising the step of:
generating a contention information data base in which information related to contention is registered on a basis of said application; and
determining contention of said application based on said data base.

10. The application contention management method according to claim 9, wherein at said data base generation step, a file with contention information of said application described on a basis of said application is read to generate said contention information data base.

11. The application contention management method according to claim 10, wherein at said data base generation step, priority of each state of the application described in said file is interpreted and registered at said contention information data base, and at said contention determination step, contention of said application is determined based on said priority information.

12. The application contention management method according to claim 10 or claim 11, wherein at said data base generation step, an activation condition for a resource in the information processing terminal is interpreted with respect to each state of the application which is described in said file and registered at said contention information data base, and at said contention determination step, contention of said application is determined based on said activation condition.

13. The application contention management method according to any of claim 10 through claim 12, wherein at said data base generation step, a resource occupation condition in the information processing terminal is interpreted with respect to each state of the application which is described in said file and registered at said contention information data base, and at said contention determination step, contention of said application is determined based on said resource occupation condition.

14. The application contention management method according to any of claim 10 through claim 13, wherein at said data base generation step, an operation instruction to other application at the time of activation of the application which is described in said file is interpreted and registered at said contention information data base, and at said application contention determination step, said operation instruction is executed at the time of activation of the application.

15. The application contention management method according to any of claim 10 through claim 14, wherein at said data base generation step, when a new application is installed from the outside of said information processing terminal, a file with contention information of the new application described which is sent at the same time is interpreted and additionally registered at said contention information data base, and at said contention determination step, contention of said application is determined based on the additionally registered contention information of the new application.

16. The application contention management method according to any of claim 10 through claim 15, wherein at said data base generation step which is operated in an external information processing terminal connected to said information processing terminal by wired or radio communication unit, data obtained by interpreting said file is transmitted and registered to and at said data base by using said communication unit.

17. A program for causing a computer to execute an application contention management method on an information processing terminal, comprising the functions of:
function of generating a contention information data base in which information related to contention is registered on a basis of said application, and
function of determining contention of said application based on said contention information data base.

18. The program according to claim 17, wherein in said data base generation function, a file with contention information of said application described on a basis of said application is read to generate said contention information data base.

19. The program according to claim 18, wherein in said data base generation function, priority of each state of the application described in said file is interpreted and registered at said contention information data base, and in said contention determination function, contention of said application is determined based on said priority information.

20. The program according to claim 18 or claim 19, wherein in said data base generation function, an activation condition for a resource in said information processing terminal is interpreted with respect to each state of the application which is described in said file and registered at said contention information data base, and in said contention determination function, contention of said application is determined based on said activation condition.

21. The program according to any of claim 18 through claim 20, wherein in said data base generation function, a resource occupation condition in said information processing terminal is interpreted with respect to each state of the application which is described in said file and registered at said contention information data base, and in said contention determination function, contention of said application is determined based on said resource occupation condition.

22. The program according to any of claim 18 through claim 21, wherein in said data base generation function, an operation instruction to other application at the time of activation of the application which is described in said file is interpreted and registered at said contention information data base, and in said contention determination function, said operation instruction is executed at the time of activation of the application.

23. The program according to any of claim 18 through claim 22, wherein in said data base generation function, when a new application is installed from the outside of said information processing terminal, a file with contention information of the new application described which is sent at the same time is interpreted and additionally registered at said contention information data base, and in said contention determination function, contention of said application is determined based on said additionally registered contention information of the new application.

24. The program according to any of claim 18 through claim 23, which in said data base generation function, operates in an external information processing terminal connected to said information processing terminal by wired or radio communication unit to transmit and register data obtained by interpreting the file with contention information of the application described to and at said contention information data base by using the communication unit.

25. An information processing terminal, comprising the application contention management system according to any of claim 1 through claim 8.

26. The information processing terminal according to claim 25, which is a portable communication terminal.
